(19) United States
(12) Patent Application Publication
(10) Pub. No.: US 2023/0030584 A1
(43) Pub. Date: Feb. 2, 2023

(54) PLATE COMPACTOR HANDLE

(71) Applicant: MILWAUKEE ELECTRIC TOOL CORPORATION, Brookfield, WI (US)

(72) Inventors: Miguel Ángel Ortuño Rodriguez, Querétaro (MX); Ian C. Richards, Shorewood, WI (US); Travis S. Mergener, Horicon, WI (US); Michael C. Reed, Milwaukee, WI (US); Katherine A. Flaherty, Brookfield, WI (US)

(21) Appl. No.: 17/877,227

(22) Filed: Jul. 29, 2022

Related U.S. Application Data
(60) Provisional application No. 63/279,403, filed on Nov. 15, 2021.
(60) Provisional application No. 63/227,556, filed on Jul. 30, 2021.

(51) Int. Cl. E01C 19/35; E02D 3/074

(52) U.S. Cl. CPC E01C 19/35; E02D 3/074

(57) ABSTRACT

A handle for a construction tool includes a lower handle portion configured to be coupled to the construction tool, an upper handle portion configured to be grasped by a user, a support pin disposed between the upper handle portion to the lower handle portion, and a locking mechanism configured to selectively secure the upper handle portion relative to the lower handle portion. The upper handle portion pivotable relative to the lower handle portion about the support pin. The locking mechanism includes a locking pin movable between a lock position, in which the upper handle portion is not pivotable relative to the lower handle portion, and an unlock position, in which the upper handle portion is pivotable relative to the lower handle portion, and a release handle configured to selectively move the locking pin between the lock position and the unlock position.

### CROSS-REFERENCE TO RELATED APPLICATIONS

This application claims priority to co-pending U.S. Provisional Patent Application No. 63/279,403, filed on Nov. 15, 2021, and to co-pending U.S. Provisional Patent Application No. 63/227,556, filed on Jul. 30, 2021, the entire contents of both of which are incorporated herein by reference.

### FIELD OF THE INVENTION

The present invention relates to walk-behind construction equipment, and more particularly to handles for walk-behind construction equipment.

### BACKGROUND OF THE INVENTION

Many types of construction equipment, such as plate compactors and early entry saws, require an operator to walk behind the equipment to manually control movement of the equipment. These types of construction equipment typically include handles to provide the operator a control mechanism for the construction equipment.

### SUMMARY OF THE INVENTION

The present invention provides, in one aspect, a handle for a construction tool. The handle includes an upper handle portion configured to be grasped by a user, a lower handle portion configured to be coupled to the construction tool, and a pivot joint. The pivot joint includes a locking pawl about which the upper handle portion pivots relative to the lower handle portion. The locking pawl is configured to selectively prevent the upper handle portion from pivoting relative to the lower handle portion. The pivot joint further includes a crossbar configured to displace the locking pawl such that, when the locking pawl is displaced, the upper handle portion is pivotable relative to the lower handle portion.

The present invention provides, in another aspect, a handle for a construction tool. The handle includes a lower handle portion configured to be coupled to the construction tool, an upper handle portion configured to be grasped by a user, a support pin disposed between the upper handle portion and the lower handle portion and configured to couple the upper handle portion to the lower handle portion, and a locking mechanism configured to selectively secure the upper handle portion relative to the lower handle portion. The upper handle portion is pivotable relative to the lower handle portion about the support pin. The locking mechanism includes a locking pin movable between a lock position, in which the upper handle portion is not pivotable relative to the lower handle portion, and an unlock position, in which the upper handle portion is pivotable relative to the lower handle portion, and a release handle configured to selectively move the locking pin between the lock position and the unlock position.

The present invention provides, in yet another aspect, a handle for a construction tool. The handle including a lower handle portion configured to be coupled to the construction tool and an upper handle portion coupled to the lower handle portion. The upper handle portion configured to selectively rotate relative to the lower handle portion between a collapsed position and a deployed position. A support pin is disposed between the upper handle portion and the lower handle portion so that the upper handle portion is rotatable relative to the lower handle portion about the support pin. A locking mechanism is configured to selectively secure the upper handle portion relative to the lower handle portion. The locking mechanism includes an inner locking pin movable between a lock position, in which the upper handle portion is not rotatable relative to the lower handle portion, and an unlock position, in which the upper handle portion is rotatable relative to the lower handle portion. An outer locking pin guide is disposed about the inner locking pin. The outer locking pin guide is configured to guide movement of the inner locking pin between the lock position and the unlock position. A release handle is configured to selectively move the inner locking pin between the lock position and the unlock position.

Other features and aspects of the invention will become apparent by consideration of the following detailed description and accompanying drawings.

### BRIEF DESCRIPTION OF THE DRAWINGS

FIG. 1 is perspective view of a plate compactor in accordance with an embodiment of the present disclosure.

FIG. 1A is another perspective view of the plate compactor of FIG. 1.

FIG. 2 is a perspective view of a handle for a plate compactor in accordance with an embodiment of the present disclosure.

FIG. 3 is a close-up perspective view of a portion of the handle of FIG. 2.

FIG. 4 is a close-up cutaway perspective view of a portion of the handle of FIG. 2.

FIG. 5 is perspective view of a handle for a plate compactor in accordance with another embodiment of the present disclosure.

FIG. 6 is a plan view of the handle of FIG. 5.

FIG. 7 is a cross-sectional view of a portion of the handle of FIG. 5, taken along section line 7-7 in FIG. 5.

FIG. 8 is a close-up perspective view of a portion of the handle of FIG. 5.

FIG. 9 is a perspective view of a handle for a plate compactor in accordance with yet another embodiment of the present disclosure.

FIG. 10 is a plan view of the handle of FIG. 9.

FIG. 11 is a cross-sectional view of a portion of the handle of FIG. 9, taken along section line 11-11 in FIG. 9.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

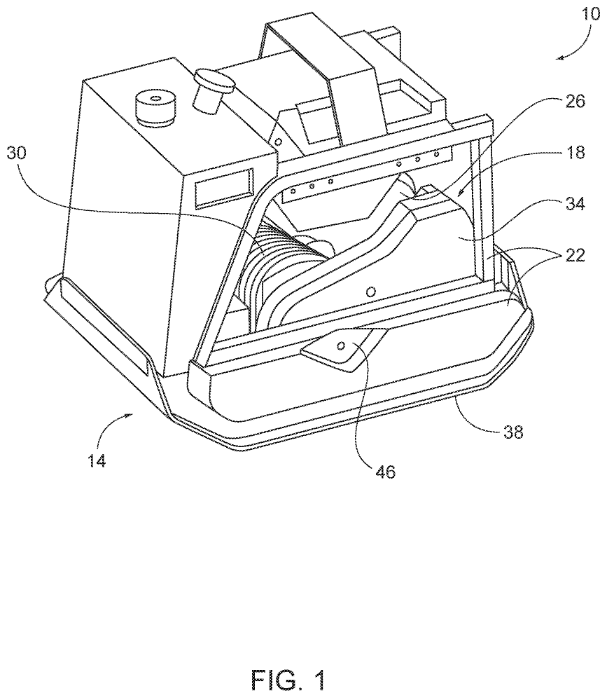

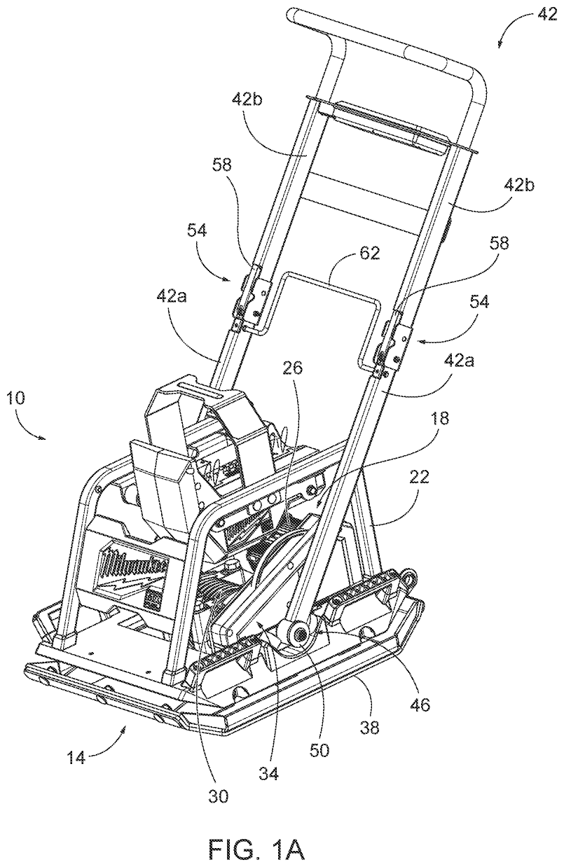

With reference to FIGS. 1 and 1A of the drawings, a type of walk-behind construction equipment, illustrated as a vibratory plate compactor 10, includes a base 14, a vibration mechanism 18 mounted upon the base 14, and a frame 22 coupled to the base 14 via vibration damping elements (e.g., rubber bushings, not shown). The vibration mechanism 18 includes an electric motor 26 (e.g., a brushless DC electric motor) and an eccentric shaft 30 driven by the motor 26 via a belt or chain drive 34. Alternatively, the motor 26 may directly drive the eccentric shaft 30 without an intervening belt or chain drive 34. The base 14 includes a compacting plate 38 such that rotation of the eccentric shaft 30 by the motor 26 induces a vibrating motion on the compacting plate 38 in a vertical direction.

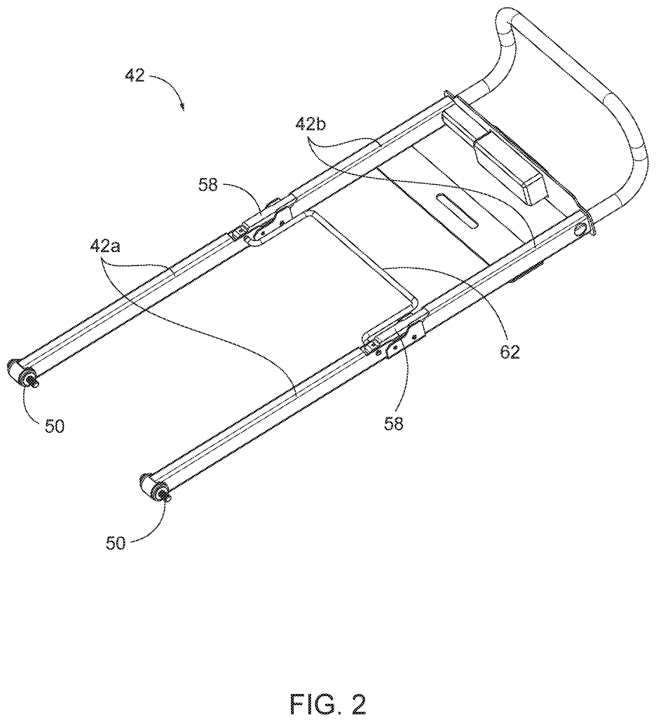

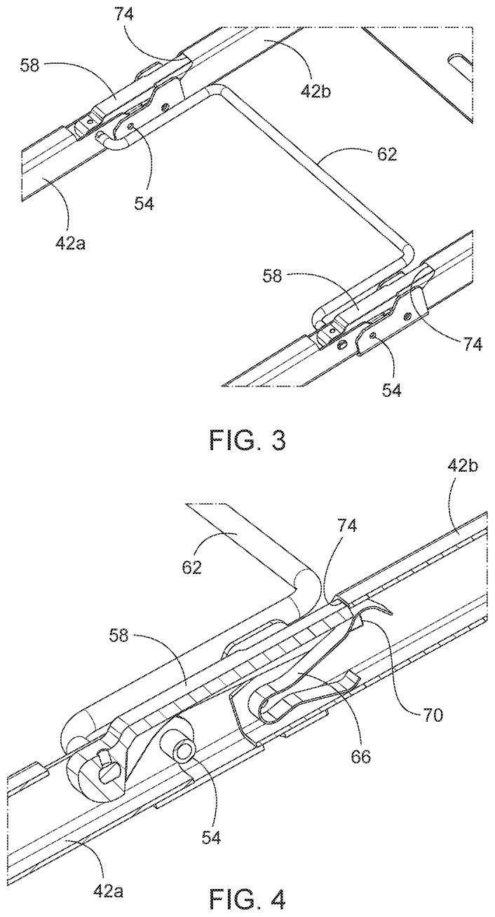

The vibratory plate compactor 10 includes a handle 42 (FIG. 2) coupled to opposite sides of the frame 22 at respective mounts 46 to permit an operator to guide the vibratory plate compactor 10 along a work surface. A bushing 50 on both ends of the handle 42 connects the handle 42 to the frame 22 in such a way that the handle 42 can pivot relative to the base 14 and the frame 22. The bushing 50 may be formed from PM brass, rubber, or other elastomeric materials. With reference to FIGS. 2 and 3, the handle 42 is also hinged so as to be foldable into a storage position when the compactor 10 is not in use. The handle 42 includes a lower handle portion 42a connected to the frame 22 via the bushings 50 as described above and an upper handle portion 42b connected to the lower handle portion 42a by a pivot joint 54. The handle 42 also includes dual locking pawls 58, which are also pivotably coupled to the lower handle portion 42a about respective axes that are parallel with the pivot axis defined by the pivot joint 54, and a crossbar 62 extending between the locking pawls 58. The crossbar 62 includes opposite ends affixed to the respective pawls 58 such that the crossbar 62 and pawls 58 are pivotable relative to the lower handle portion 42a as a unit. Furthermore, the handle 42 includes leaf springs 66 in the upper handle portion 42b that bias the respective pawls 58 in a counter-clockwise direction from the frame of reference of FIG. 4.

In the locked position shown in FIGS. 3 and 4, the pawls 58 prevent the upper handle portion 42b from being pivoted relative to the lower handle portion 42a to collapse the handle 42 into its storage position. Specifically, each of the pawls 58 includes a notch 70 at its distal end that is engaged with an associated stop 74 (e.g., a straight interior edge) on the upper handle portion 42b. If it is attempted to pivot the upper handle portion 42b toward its collapsed storage position with the pawls 58 in the locked position, the stops 74 on the upper handle portion 42b will bind against the pawls 58, preventing further pivoting movement about the joint 54.

To pivot the pawls 58 into the release position, the crossbar 62 and the pawls 58 are pivoted downward, in a clockwise direction from the frame of reference of FIGS. 3 and 4, against the bias of the leaf springs 66 until the notches 70 clear the stops 74. With the crossbar 62 and pawls 58 held in the release position, the upper handle portion 42b is pivoted relative to the lower handle portion 42a about the joint 54 in a counter-clockwise direction from the frame of reference of FIG. 4 to collapse the handle 42 into its storage position. As the upper handle portion 42b pivots, the pawls 58 move into the interior of the upper handle portion 42b and then pivot about their respective axes in a counter-clockwise direction from the frame of reference of FIG. 4 along with the upper handle portion 42b as the handle 42 is collapsed to the storage position.

The handle 42 has been described in relation to a vibratory plate compactor 10. However, as will be understood by one having ordinary skill in the art, the handle 42 can alternatively be utilized with other walk-behind construction equipment (e.g., an early entry saw).

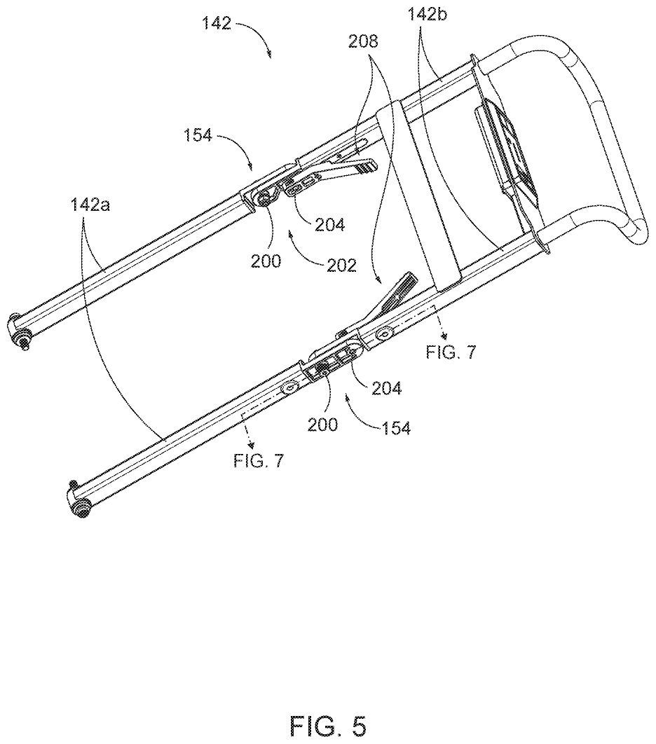

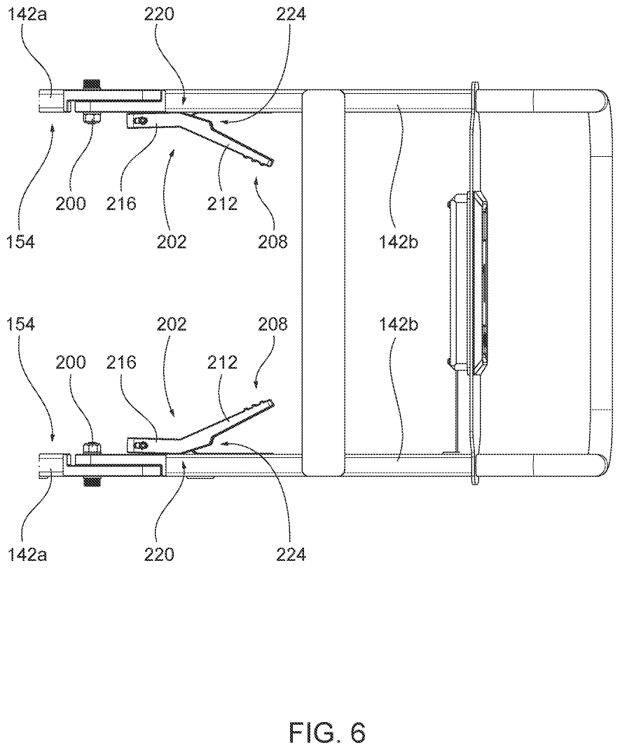

FIGS. 5-8 illustrate another embodiment of the handle 142 for use with a piece of walk-behind construction equipment, with like parts having like reference numerals plus the number “1” appended thereon and the following differences explained below. The handle 142 includes a lower handle portion 142a configured to be pivotally coupled to the frame 122. The handle 142 further includes an upper handle portion 142b connected to the lower handle portion 142a by pivot joints 154. The pivot joints 154 allow the upper handle portion 142b to rotate relative to the lower handle portion 142a between a collapsed, storage, position, and a deployed position, as described above in relation to the first handle embodiment.

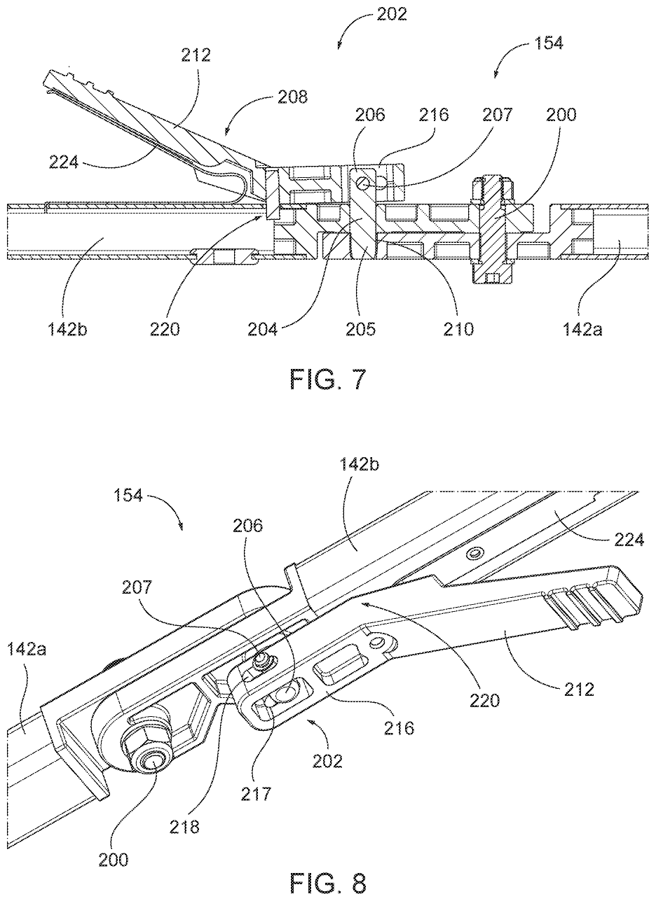

With reference to FIG. 7, each pivot joint 154 includes a support pin 200 configured to couple the upper handle portion 142b to the lower handle portion 142a. The support pin 200 secures the upper handle portion 142b relative to the lower handle portion 142a while allowing the upper handle portion 142b to rotate relative to the lower handle portion 142a about a longitudinal axis of the support pin 200. In the illustrated embodiment, the support pins 200 are oriented such that their longitudinal axes extend laterally with respect to the construction equipment and parallel to an axis of rotation of the lower handle portion 142a relative to the frame 122.

A locking mechanism 202 is coupled to each pivot joint 154 to selectively secure the upper handle portion 142b in the deployed position. The locking mechanism 202 includes locking pins 204 configured to selectively rotationally couple the upper handle portion 142b and the lower handle portion 142a. The locking pins 204 are supported by the upper handle portion 142b, oriented parallel to the support pins 200, and spaced from the support pins 200. Furthermore, the locking pins 204 are moveable between a lock position and an unlock position. In the lock position, the locking pin 204 engages both the upper handle portion 142b and the lower handle portion 142a. Therefore, the locking pin 204 prevents the upper handle portion 142b from rotating relative to the lower handle portion 142a about the support pin 200. In the unlock position, the locking pin 204 is displaced along its longitudinal axis such that the lower handle portion 142a is no longer engaged by the locking pin 204. Therefore, the upper handle portion 142b is rotatable relative to the lower handle portion 142a about the support pin 200.

As shown in FIG. 7, each locking pin 204 includes an exterior end 205 and an interior end 206. The exterior end 205 is configured to engage a cylindrical hole 210 in the lower handle portion 142a when the locking pin 204 is in the lock position. The interior end 206 supports a cross-pin 207 oriented transverse to a longitudinal axis of the locking pin 204 and configured to couple the locking pin 204 to the locking mechanism 202.

The locking mechanism 202 further includes a release handle 208 coupled to each locking pin 204 and configured to control movement of the locking pin 204 between the lock and unlock positions. In the illustrated embodiment, the release handles 208 are disposed on interior surfaces of the upper handle portion 142b. The release handles 208 include user graspable portions 212 extending away from the upper handle portion 142b and locking pin support portions 216 oriented parallel to the upper handle portion 142b. The user graspable portions 212 and locking pin support portions 216 are oriented at a non-straight angle relative to one another (e.g., not 180 degrees, 25 degrees in the illustrated embodiment) such that the user graspable portions 212 extend laterally inward relative to the construction equipment. A fulcrum 220 is defined as a point on the release handle 208 at which the user graspable portion 212 transitions to the locking pin support portion 216 and about which the release handle 208 rotates when actuated. The locking pin support portion 216 is coupled to the locking pin 204 to allow a small amount of relative movement between the two. Specifically, the locking pin support portion 216 includes an opening 217 into which the interior end 206 of the locking pin 204 extends and a pair of cross-bores 218 that receive opposite ends of the cross-pin 207, respectively (FIG. 8). As the locking pin support portion 216 rotates about the fulcrum 220, the locking pin 204 is displaced axially. The locking pin support portion 216 rotates about the fulcrum 220 due to motion of the user graspable portion 212. Specifically, as the user graspable portion 212 moves toward the upper handle portion 142b, the locking pin support portion 216 moves away from the upper handle portion 142b to move the locking pin 204 from the lock position toward the unlock position. In order for the locking pin 204 to be displaced axially, the cross-pin 207 slides within the cross-bores 218 while the locking pin 204 is pulled straight out of the cylindrical hole 210 in the lower handle portion 142a. A biasing mechanism, illustrated as a leaf spring 224, is configured to engage the upper handle portion 142b and the user graspable portion 212, such that the release handle 208 is biased to a position corresponding to the locking pin 204 being in the lock position. In the illustrated embodiment, the leaf spring 224 is affixed to the upper handle portion 142b and the release handle 208 secure the release handle 208 to the upper handle portion 142b. In other embodiments, the release handle 208 may be rotationally coupled to the upper handle portion 142b near the fulcrum 220. For example, the fulcrum 220 may include a pin securing the release handle 208 to the upper handle portion 142b and about which the release handle 208 rotates.

To rotate the upper handle portion 142b relative to the lower handle portion 142a, an operator must displace the user graspable portions 212 of each release handle 208 against the biasing force of the leaf springs 224 such that the locking pins 204 move from the lock position to the unlock position. As described above, when in the unlock position, the locking pins 204 disengage the lower handle portion 142a and allow the upper handle portion 142b to rotate relative to the lower handle portion 142a about the support pins 200.

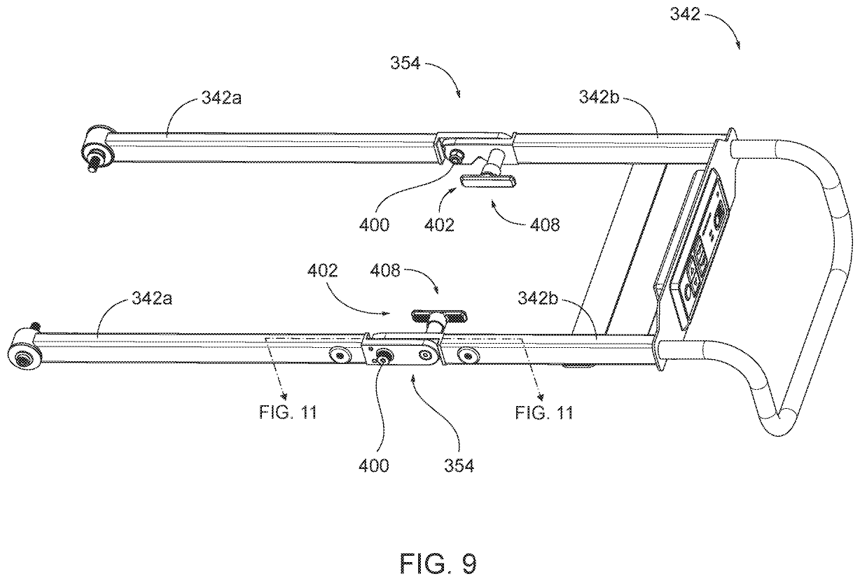

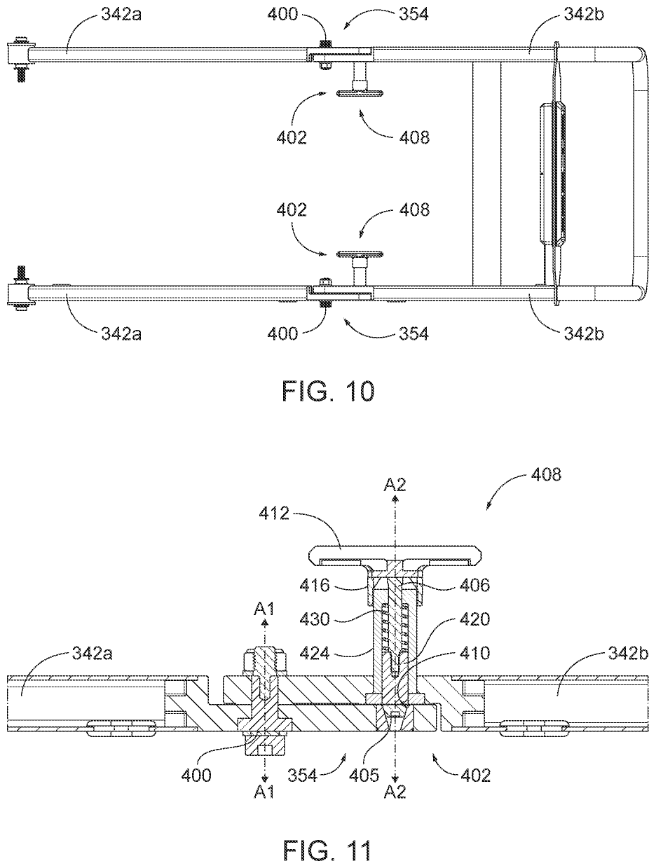

FIG. 9-11 illustrate another embodiment of a handle 342 for use with a piece of walk-behind construction equipment. The handle 342 includes a lower handle portion 342a configured to be pivotally coupled to the frame 322. The handle 342 further includes an upper handle portion 342b connected to the lower handle portion 342a by pivot joints 354. The pivot joints 354 allow the upper handle portion 342b to rotate relative to the lower handle portion 342a between a collapsed, storage position, and an extended, deployed position, as described above in relation to the first handle embodiment.

With reference to FIG. 11, each pivot joint 354 includes a support pin 400 configured to couple the upper handle portion 342b to the lower handle portion 342a. The support pin 400 secures the upper handle portion 342b relative to the lower handle portion 342a while allowing the upper handle portion 342b to rotate relative to the lower handle portion 342a about a longitudinal axis A1 of the support pin 400. In the illustrated embodiment, the support pins 400 are oriented such that their longitudinal axes extend laterally with respect to the construction equipment and parallel to an axis of rotation of the lower handle portion 342a relative to the frame 322.

A locking mechanism 402 is coupled to each pivot joint 354 to selectively secure the upper handle portion 342b in the deployed position. The locking mechanism 402 includes an inner locking pin 420 (FIG. 11) configured to selectively and rotationally couple the upper handle portion 342b and the lower handle portion 342a. The inner locking pins 420 are supported by the upper handle portion 342b, include a longitudinal axis A2 oriented parallel to the support pins 400, and spaced apart from the support pins 400. Furthermore, the inner locking pins 420 are moveable along the longitudinal axis A2 between a lock position and an unlock position. In the lock position, the inner locking pin 420 engages both the upper handle portion 342b and the lower handle portion 342a. Therefore, the inner locking pin 420 prevents the upper handle portion 342b from rotating relative to the lower handle portion 342a about the support pin 400. In the unlock position, the inner locking pin 420 is displaced along its longitudinal axis A2 such that the lower handle portion 342a is no longer engaged by the inner locking pin 420. Therefore, the upper handle portion 342b is rotatable relative to the lower handle portion 342a about the support pin.

Referring again to FIG. 11, each locking mechanism 402 further includes an outer locking pin guide 424 disposed about the inner locking pin 420. The outer locking pin guide 424 is a hollow cylindrical body fixed relative to the upper handle portion 342b. The inner locking pin 420 includes an exterior end 405 and an interior end 406. The exterior end 405 is frustoconical and configured to engage a frustoconical bore 410 in the lower handle portion 342a when the inner locking pin 420 is in the lock position. However, in other embodiments, the exterior end 405 and the bore 410 may have non-frustoconical shapes so long as the shape as the exterior end 405 corresponds with the shape of the bore 410. The interior end 406 is coupled to a T-shaped release handle 408 that is controls movement of the inner locking pin 420 between the lock and unlock positions. Therefore, the release handle 408 is affixed to and moves in unison with the inner locking pin 420 between the lock and unlock positions. The release handle 408 includes a user-graspable portion 412 forming the cross-bar of the T-shape and a locking pin support portion 416 coaxial with a longitudinal axis of the inner locking pin 420 and coupled to the inner locking pin 420. The locking pin support portion 416 is formed as a hollow, cylindrical body that surrounds a portion of the outer locking pin guide 424 and is movable relative to the outer locking pin guide 424. Disposed between the inner locking pin 420 and the outer locking pin guide 424 is a biasing member, illustrated as a compression spring 430, that biases the inner locking pin 420 and the release handle 408 towards the lock position.

To rotate the upper handle portion 342b relative to the lower handle portion 342a, an operator must displace the release handle 408 by grasping the user-graspable portion 412 and moving the release handle 408 towards the unlock position. Movement of the release handle 408 moves the inner locking pin 420 against the biasing force of the compression spring 430 within the outer locking pin guide 424 to disengage the inner locking pin 420 from the lower handle portion 342a, thereby unlocking the locking mechanism 402 and allowing the upper handle portion 342b to rotate relative to the lower handle portion 342a.

Although the invention has been described in detail with reference to certain preferred embodiments, variations and modifications exist within the scope and spirit of one or more independent aspects of the invention as described.

Various features and aspects of the present invention are set forth in the following claims.

What is claimed is:

1. A handle for a construction tool, the handle comprising:
an upper handle portion configured to be grasped by a user;
a lower handle portion configured to be coupled to the construction tool; and
a pivot joint including
a locking pawl about which the upper handle portion pivots relative to the lower handle portion, the locking pawl configured to selectively prevent the upper handle portion from pivoting relative to the lower handle portion, and
a crossbar configured to displace the locking pawl such that, when the locking pawl is displaced, the upper handle portion is pivotable relative to the lower handle portion.

2. The handle of claim 1, further comprising a bushing disposed on the lower handle portion, the bushing configured to couple the handle to the construction tool, wherein the bushing is formed of an elastomeric material.

3. The handle of claim 1, further comprising a spring disposed within the upper handle portion, the spring configured to bias the locking pawl toward a locked position in which the upper handle portion is prevented from being pivoted relative to the lower handle portion.

4. The handle of claim 3, wherein, when the locking pawl is in the locked position, a notch on the locking pawl engages a stop on the upper handle portion.

5. The handle of claim 4, wherein, when the locking pawl in in an unlocked position, the pawl is disposed within the upper handle portion and pivotable relative to the lower handle portion with the upper handle portion.

6. A handle for a construction tool, the handle comprising:
a lower handle portion configured to be coupled to the construction tool;
an upper handle portion configured to be grasped by a user;
a support pin disposed between the upper handle portion to the lower handle portion and configured to couple the upper handle portion to the lower handle portion, the upper handle portion pivotable relative to the lower handle portion about the support pin; and
a locking mechanism configured to selectively secure the upper handle portion relative to the lower handle portion, the locking mechanism including
a locking pin movable between a lock position, in which the upper handle portion is not pivotable relative to the lower handle portion, and an unlock position, in which the upper handle portion is pivotable relative to the lower handle portion, and
a release handle configured to selectively move the locking pin between the lock position and the unlock position.

7. The handle of claim 6, further comprising a biasing member configured to bias the release handle and the locking pin toward the lock position.

8. The handle of claim 7, wherein the biasing member is a leaf spring, and wherein the leaf spring is disposed between the upper handle portion and the release handle.

9. The handle of claim 6, wherein the release handle includes a user graspable portion and a locking pin support portion, the user graspable portion angled relative to the locking pin support portion, wherein a fulcrum is defined at a point of intersection between the user graspable portion and the locking pin support portion, and wherein the release handle pivots about the fulcrum to move the locking pin between the lock position and the unlock position.

10. The handle of claim 6, further comprising a bushing disposed on the lower handle portion, the bushing configured to couple the handle to the construction tool, wherein the bushing is formed of an elastomeric material.

11. The handle of claim 6, wherein the locking mechanism is fixed to the upper handle portion and, when the locking pin is in the unlock position, the locking mechanism is pivotable relative to the lower handle portion with the upper handle portion.

12. The handle of claim 11, wherein, when the locking pin is in the lock position, the locking pin engages the upper handle portion and the lower handle portion.

13. The handle of claim 6, wherein the locking pin is a first locking pin and the release handle is a first release handle, wherein the locking mechanism further includes a second locking pin and a second release handle, and wherein the second locking pin and the second release handle are disposed on an opposite side of the upper handle portion as the first locking pin and the first release handle.

14. The handle of claim 13, wherein the first locking pin and the second locking pin move toward one another when moving from the lock position toward the unlock position.

15. A handle for a construction tool, the handle comprising:
a lower handle portion configured to be coupled to the construction tool;
an upper handle portion coupled to the lower handle portion, the upper handle portion configured to selectively rotate relative to the lower handle portion between a collapsed position and a deployed position;
a support pin disposed between the upper handle portion and the lower handle portion, the upper handle portion rotatable relative to the lower handle portion about the support pin; and
a locking mechanism configured to selectively secure the upper handle portion relative to the lower handle portion, the locking mechanism including
an inner locking pin movable between a lock position, in which the upper handle portion is not rotatable relative to the lower handle portion, and an unlock position, in which the upper handle portion is rotatable relative to the lower handle portion,
an outer locking pin guide disposed about the inner locking pin, the outer locking pin guide configured to guide movement of the inner locking pin between the lock position and the unlock position, and
a release handle configured to selectively move the inner locking pin between the lock position and the unlock position.

16. The handle of claim 15, further comprising a compression spring configured to bias the inner locking pin towards the lock position.

17. The handle of claim 15, wherein the outer locking pin guide is fixed relative to the upper handle portion.

18. The handle of claim 15, wherein the release handle and the inner locking pin are movable relative to the outer locking pin guide.

19. The handle of claim 15, wherein the inner locking pin is movable along a direction parallel to an axis about which the upper handle portion is rotatable relative to the lower handle portion.

20. The handle of claim 15, further comprising a bushing disposed on the lower handle portion, the bushing configured to couple the handle to the construction tool, wherein the bushing is formed of an elastomeric material.
